(19) United States
(12) Patent Application Publication
(10) Pub. No.: US 2022/0310038 A1
(43) Pub. Date: Sep. 29, 2022

(54) INFORMATION PROCESSING SYSTEM, INFORMATION PROCESSING METHOD, AND NON-TRANSITORY RECORDING MEDIUM

(71) Applicant: Daigo TAGUCHI, Kanagawa (JP)

(72) Inventor: Daigo TAGUCHI, Kanagawa (JP)

(21) Appl. No.: 17/692,204

(22) Filed: Mar. 11, 2022

(30) Foreign Application Priority Data
Mar. 23, 2021 (JP) 2021-048181

(51) Int. Cl. G09G 5/14; G06F 3/14; G06V 30/32; H04L 12/18

(52) U.S. Cl. CPC G09G 5/14; G06F 3/1454; G06V 30/32; H04L 12/1831; H04L 12/1822; G09G 2370/027; G09G 2354/00

(57) ABSTRACT

An information processing system, an information processing method, and a non-transitory recording medium. An information processing system displays an image transmitted from one of the information processing terminals on displays of other information processing terminals, stores information input by users of the information processing terminals with respect to the image displayed on each information processing terminal, calculates degree of interest in a specific image identified by specific identification information for each user, by comparing an aggregated value of the input information related to the specific image for each user with the aggregated value for each user related to another image or a plurality of other images identified respectively by other identification information, and causes the information processing terminal that transmitted the specific image to display on a display, information indicating the degree of interest of each user.

### CROSS-REFERENCE TO RELATED APPLICATIONS

This patent application is based on and claims priority pursuant to 35 U.S.C. § 119(a) to Japanese Patent Application No. 2021-048181, filed on Mar. 23, 2021, in the Japan Patent Office, the entire disclosure of which is hereby incorporated by reference herein.

### BACKGROUND

### Technical Field

The present disclosure relates to an information processing system, an information processing method, and a non-transitory recording medium.

### Related Art

An organizer of an event held by participation of multiple people, such as a meeting, a seminar, a product information session, and a class, investigates how interested the participants were by using questionnaires from each participant and seek a way to hold the event so that the participants will be interested in the next event.

A method of determining importance of each meeting material based on a number of operations on the meeting material and the like is disclosed. In this method, a coefficient is assigned according to a role of a person performing an operation (leader, member, observer, etc.) and according to the role of the person who operated the meeting material, a number of operations on the meeting material is calculated by weighting each operation with respective coefficient.

### SUMMARY

Embodiments of the present disclosure describe an information processing system, an information processing method, and a non-transitory recording medium. The information processing system controls to display an image transmitted from one of the plurality of information processing terminals on each of a plurality of displays of other information processing terminals of the plurality of information processing terminals, stores as associated information in one or more memories, input information input by each of respective users of the plurality of information processing terminals with respect to the image displayed on each information processing terminal in association with identification information of the image, calculates, for each user, degree of interest in a specific image identified by specific identification information, by comparing an aggregated value of the input information related to the specific image identified by the specific identification information calculated from the associated information, with the aggregated value related to one or more other image each identified by another identification information different from the specific image identified by the specific identification information, and causes the information processing terminal that transmitted the specific image identified by the specific identification information to display on the display, information indicating the degree of interest of each user related to the specific image identified by the specific identification information.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of an overview of an information processing system during a meeting according to embodiments of the present disclosure;

FIG. 2 is a diagram illustrating an outline of a personal portal and an organizer portal in the information processing system;

FIG. 3 is a block diagram illustrating an example of a hardware configuration of a computer;

FIG. 4 is a block diagram illustrating an example of a hardware configuration of a smartphone;

FIG. 5 is a block diagram illustrating an example of a hardware configuration of a projector;

FIG. 6 is a block diagram illustrating an example of a hardware configuration of an interactive whiteboard (IWB);

FIG. 7 is a block diagram illustrating an example of a functional configuration of the information processing system;

FIG. 8 is a diagram illustrating an example of a personal board screen;

FIG. 9 is a diagram illustrating an example of the personal board screen displaying a projection screen;

FIG. 10 is a diagram illustrating an example of the personal board screen displaying a captured screen;

FIG. 11 is a diagram illustrating an example of the personal board screen displaying a memo area on the lower side;

FIG. 12 is a diagram illustrating an example of the personal board screen displaying three or more captured screens;

FIG. 13 is a table illustrating an example of a configuration of a personal memo management database (DB);

FIG. 14 is a table illustrating an example of a configuration of a shared memo management DB;

FIG. 15 is a table illustrating an example of a configuration of a personal memo DB;

FIG. 16 is a table illustrating an example of a configuration of an aggregation DB;

FIG. 17 is a flowchart illustrating an example of a process executed by the information processing system;

FIG. 18 is a sequence diagram illustrating an example of a process from meeting preparation to displaying a projection screen on the personal board screen;

FIG. 19 is a diagram illustrating an example of a screen when a presenter selects “share whole screen”;

FIG. 20 is a sequence diagram illustrating an example of a process of acquiring an aggregated result of an individual's interest in a meeting on an organizer terminal;

FIG. 21 is a diagram illustrating an example of a meeting list screen displayed on an organizer portal screen; and

FIGS. 22A and 22B are tables illustrating examples of a result screen displayed on the organizer terminal.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, a description is given of several embodiments of an information processing system, an information processing method, and a non-transitory recording medium. In the present embodiment, an example of the information processing system used for a meeting is described, but the present disclosure is not limited to the meeting. The present embodiment is not limited to the meeting and applies to various information processing systems for an event held by a plurality of participants such as seminars, lectures, and classes. The participants may actually gather at the same place to participate in the event to be held or may participate in other places. In the present embodiment, an example of a remote meeting in which participants are remotely connected is described, but all participants may be in the same room and do not have to be physically separated from each other.

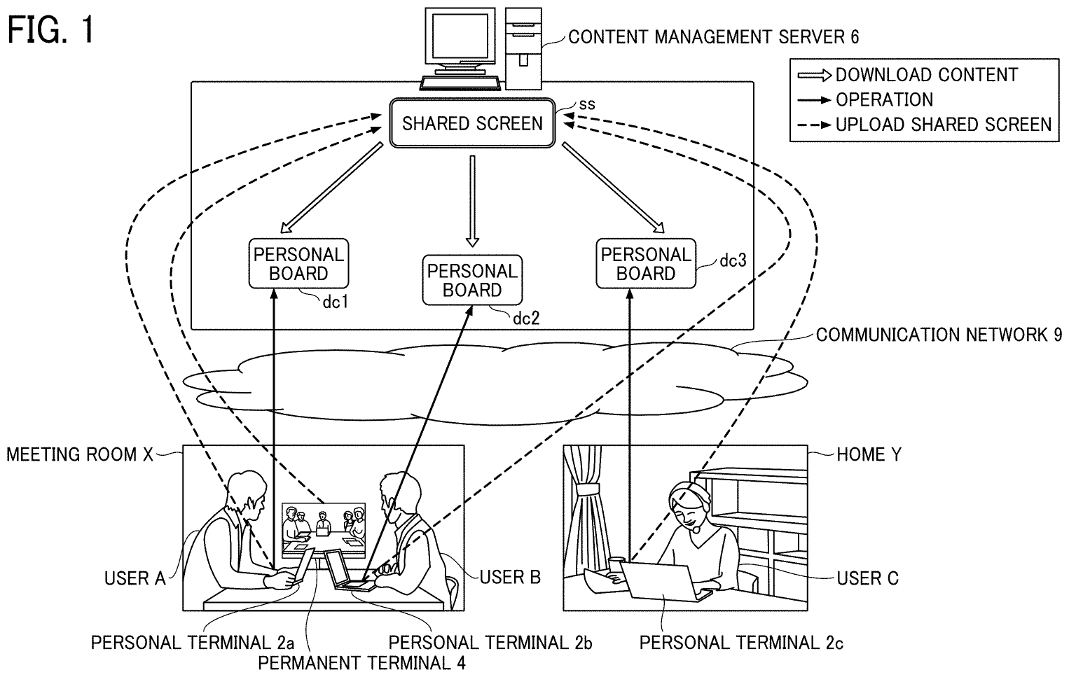

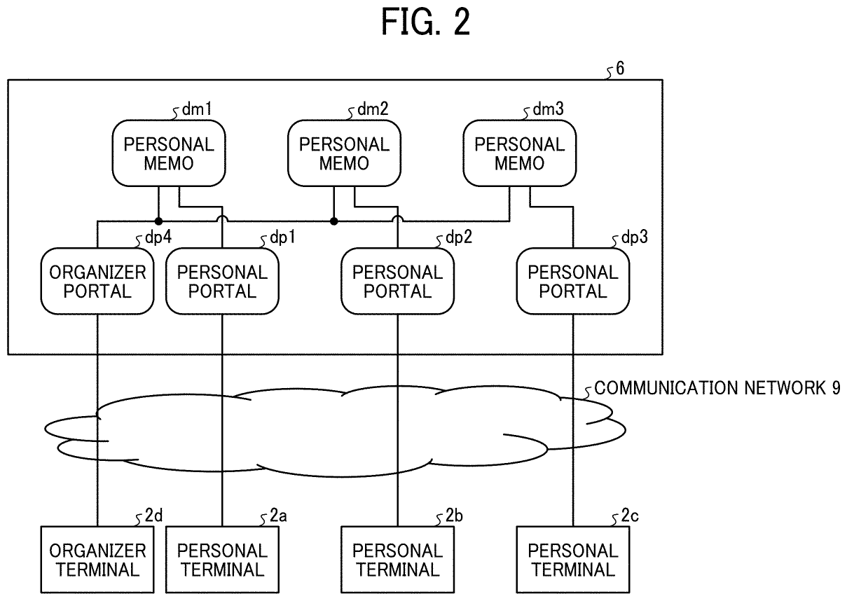

With reference to FIG. 1, an overview of the information processing system according to the present embodiment is described. FIG. 1 is a diagram illustrating an example of an overview of an information processing system during a meeting. In the example illustrated in FIG. 1, a user A and a user B are in the meeting room X of a company and a user C is at home Y and the users are holding a remote meeting by using the information processing system. The user A uses a personal terminal 2a in the meeting room X, and the user B uses a personal terminal 2b in the meeting room X. In the meeting room X, a permanent terminal 4 that can be shared by a plurality of users is installed. The permanent terminal 4 may not be present. The information processing system may be implemented without the permanent terminal 4. The user C brings a personal terminal 2c to his or her home Y. In the following description, the personal terminal 2a, the personal terminal 2b, and the personal terminal 2c are collectively referred to as a “personal terminal 2” or “personal terminals 2”, unless these terminals need to be distinguished from each other. After the meeting, an organizer of the meeting confirms aggregated results such as memos of the meeting taken by participants of the meeting on an information processing terminal. The information processing terminal used by the organizer is referred to as an organizer terminal for the sake of explanation, but the organizer terminal may be a personal terminal. Configurations of the personal terminal 2, the organizer terminal 2d (FIG. 2), and the permanent terminal 4 are described below.

The personal terminal 2 and the organizer terminal 2d are computers used individually (exclusively) by the user, for example, for viewing a screen. The permanent terminal 4 is a computer used and viewed by a plurality of users jointly.

The personal terminal 2 and the organizer terminal 2d are, for example, a notebook personal computer (PC), a desktop PC, a mobile phone, a smartphone, a tablet terminal, a wearable PC, and the like. The personal terminal 2 and the organizer terminal 2d are examples of information processing terminals.

Examples of the permanent terminal 4 includes, but not limited to a projector (PJ), an IWB, a digital signage, a display to which a stick PC is connected. The IWB is a whiteboard having an electronic whiteboard function and mutual communication capability. The permanent terminal 4 is an example of the information processing terminal.

The personal terminal 2, the organizer terminal 2d, and the permanent terminal 4 communicate with a content management server 6 through a communication network 9 such as the internet. The communication network 9 is, for example, one or more local area networks (LANs) inside the firewall. In another example, the communication network 9 includes the internet that is outside the firewall in addition to the LAN. In still another example, the communication network 9 may include a virtual private network (VPN) and a wide-area ETHERNET (registered trademark). The communication network 9 is any one of a wired network, a wireless network, and a combination of the wired network and the wireless network. In a case where the content management server 6 and the personal terminal 2 connects to the communication network 9 through a mobile phone network such as 3G, Long Term Evolution (LTE), 4G, the LAN can be omitted.

The content management server 6 is an example of the information processing apparatus. The content management server 6 is a computer including a function as a web server (or Hypertext Transfer Protocol (HTTP) server) that stores and manages content data to be transmitted to the personal terminal 2, the organizer terminal 2d, and the permanent terminal 4. The content management server 6 includes a storage unit 6000 described below.

The storage unit 6000 includes storage area for implementing personal boards dc1 to personal board dc3, which are accessible only from each personal terminal 2. Only the personal terminals 2a, 2b, and 2c can access the personal boards dc1, dc2, and dc3, respectively. In the following description, the personal board dc1, the personal board dc2, and the personal board dc3 are collectively referred to as a “personal board dc”, unless these boards need to be distinguished from each other. In one example, the content management server 6 supports cloud computing. The cloud computing refers to a usage pattern in which resources on a network are used without being aware of specific hardware resources.

Further, the storage unit 6000 of the content management server 6 includes a storage area for implementing a shared screen ss that can be accessed from each personal terminal 2.

The personal board dc is a virtual space created in the storage area in the storage unit 6000 of the content management server 6. For example, the personal board dc is accessible by using a web application having a function of allowing a user to view and edit contents with the Canvas element and JAVASCRIPT (registered trademark). A web application refers to software used on a web browser application or its mechanism. The web application operates by coordinating a program in a script language (for example, JAVASCRIPT (registered trademark)) that operates on a web browser application (hereinafter referred to as web browser) with a program on the web server. The personal board dc includes a finite or an infinite area within the range of the storage area in the storage unit 6000. For example, the personal board dc may be finite or infinite in both the vertical and horizontal directions or may be finite or infinite in either the vertical or horizontal directions.

The shared screen ss is a virtual space created in the storage area in the storage unit 6000 of the content management server 6. Unlike the personal board dc, the shared screen ss includes a function of simply holding data of content to be transmitted (delivered) to the personal terminal 2 or the permanent terminal 4 and holding previous content until next content is acquired. The shared screen ss can be accessed by a web application including a function of browsing the content.

The personal board dc is an electronic space dedicated to each of the users participating in the meeting. The personal terminal 2 of each user can access only the personal board dc dedicated to the corresponding user, which allows the corresponding user to view and edit (input, delete, copy, etc.) content such as characters and images on the accessed personal electronic space.

The shared screen ss is an electronic space shared by the users participating in the meeting. Each user's personal terminal 2 can access the shared screen ss and browse the shared screen ss. Unlike the personal board dc, the shared screen ss includes a function of simply holding data of content to be transmitted (delivered) to the personal terminal 2 or the permanent terminal 4 and holding previous content until next content is acquired.

For example, in a case where data of content is transmitted from the personal terminal 2a to the shared screen ss and thereafter the data of content is transmitted from the personal terminal 2b to the shared screen ss, the data of content held by the shared screen ss is the data received latest. For example, on the shared screen ss, a computer screen such as an application screen shared by the users is displayed.

The content management server 6 stores, for each virtual meeting room, information (data) such as content developed on the shared screen ss and the personal board dc in association with the corresponding virtual meeting room. The virtual meeting room is an example of a virtual room. Hereinafter, the virtual meeting room is referred to as a “room”, in order to simplify the description. Thereby, even when the content management server 6 manages plural rooms, data of content is not communicated over different rooms.

Since each personal terminal 2 can display the content of the personal board dc and the shared screen ss of the room in which the user participates by the web application of the installed web browser, the meeting can be held close to an actual meeting room.

With such an information processing system, users can share personal files opened in applications on the shared screen ss, import the content shared on the shared screen ss into the personal board dc as personal material, or by inputting handwriting, object arrangement, etc. on the personal board dc, personal memos can be kept as input information.

With reference to FIG. 2, an outline of the personal portal and the organizer portal is described. FIG. 2 is a diagram illustrating the outline of the personal portal and the organizer portal in the information processing system. The content management server 6 generates data for a personal portal screen dp1, a personal portal screen dp2, and a personal portal screen dp3 dedicated to the personal terminal 2a, the personal terminal 2b, and the personal terminal 2c, respectively, to cause the personal terminals 2 to perform display based on the generated data. In the following description, the personal portal screen dp1, the personal portal screen dp2, and the personal portal screen dp3 are collectively referred to as a “personal portal screen dp”, unless these portal screens need to be distinguished from each other. Further, the content management server 6 generates data of the dedicated organizer portal screen dp4 of the organizer terminal 2d and causes the organizer terminal 2d to display the organizer portal screen dp4.

The content management server 6 stores personal memos dm1, dm2, and dm3, which are the content edited by the personal board de of FIG. 1. In the following description, the personal memo dm1, the personal memo dm2, and the personal memo dm3 are collectively referred to as a “personal memo dm”, unless these personal memos need to be distinguished from each other. Each user that accesses the personal portal screen dp dedicated to each personal terminal 2 causes to display a list of meetings in which the user who operates the corresponding personal terminal 2 has participated.

The user can cause the personal memo dm of each meeting and reference information of the meeting to be displayed from the list of meetings displayed on the personal portal screen dp (dp1, dp2, dp3), as described below. Thus, for example, when a user wants to look back content of the meetings, the user can cause the personal memo dm of a desired meeting and the reference information of the desired meeting to be displayed in a simple manner. Further, each user accesses the personal portal screen dp dedicated to each personal terminal 2 to search the list of the meetings of the user operating the corresponding personal terminal 2 for the desired meeting by using a keyword (text). For example, the reference information of the meeting and text data and handwritten characters included in the personal memo dm are searched through by using characters (text). Note that the reference information of the meeting is included in the meeting information.

On the other hand, the organizer accesses the dedicated organizer portal screen dp4 of the organizer terminal 2d to display information indicating a degree of interest of the user who participated in the meeting hosted by the organizer. In the present embodiment, for each user, the degree of interest in the current meeting hosted by the organizer is obtained from the degree of interest in the past meetings of the user.

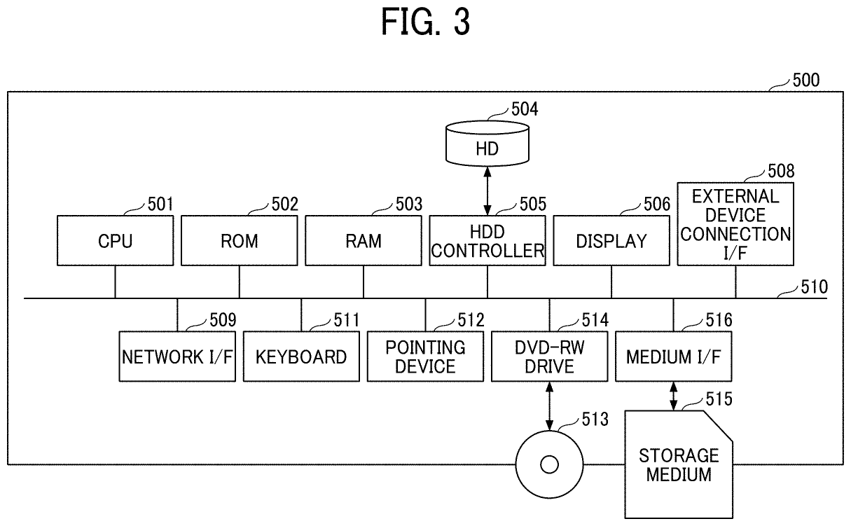

The content management server 6 is implemented by, for example, a computer 500 having a hardware configuration as illustrated in FIG. 3. Further, the personal terminal 2 or the organizer terminal 2d may be a PC which is an example of the information processing terminal, for example, implemented by the computer 500 having the hardware configuration illustrated in FIG. 3.

FIG. 3 is a block diagram illustrating an example of the hardware configuration of the computer 500, according to the present embodiment. As illustrated in FIG. 3, the computer 500 includes a central processing unit (CPU) 501, a read only memory (ROM) 502, a random access memory (RAM) 503, a hard disk (HD) 504, a hard disk drive (HDD) controller 505, a display 506, an external device connection interface (I/F) 508, a network I/F 509, a data bus 510, a keyboard 511, a pointing device 512, a Digital Versatile Disc-Rewritable (DVD-RW) drive 514, and a medium I/F 516.

Among these elements, the CPU 501 controls entire operation of the computer 500. The ROM 502 stores a control program such as an initial program loader (IPL) to boot the CPU 501. The RAM 503 is used as a work area for the CPU 501. The HD 504 stores various data such as the programs. The HDD controller 505 controls reading and writing of various data from and to the HD 504 under control of the CPU 501.

The display 506 displays various information such as a cursor, menu, window, character, or image. The external device connection I/F 508 is an interface for connecting various external devices. Examples of the external devices include, but not limited to, a Universal Serial Bus (USB) memory and a printer. The network I/F 509 is an interface that controls communication of data with the external device through the communication network 9. The data bus 510 is an address bus, a data bus, or the like for electrically connecting each element such as the CPU 501.

The keyboard 511 is an example of an input device provided with a plurality of keys for allowing a user to input characters, numerals, or various instructions. The pointing device 512 is an example of the input device that allows a user to select or execute a specific instruction, select a target for processing, or move a cursor being displayed. The DVD-RW drive 514 reads and writes various data from and to a DVD-RW 513, which is an example of a removable storage medium. The removable storage medium is not limited to the DVD-RW and may be a digital versatile disc-recordable (DVD-R) or the like. The medium I/F 516 controls reading and writing (storing) of data from and to a storage medium 515 such as a flash memory.

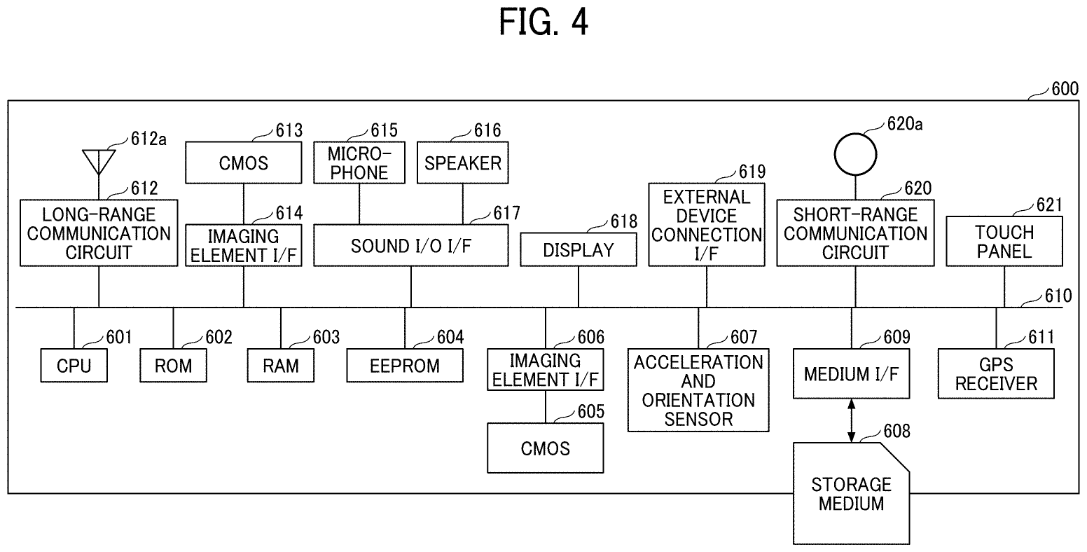

The personal terminal 2 and the organizer terminal 2d, which are examples of the information processing terminals, may be implemented by, for example, a smartphone 600 having a hardware configuration illustrated in FIG. 4.

FIG. 4 is a block diagram illustrating an example of the hardware configuration of the smartphone 600, according to the present embodiment. As illustrated in FIG. 4, the smartphone 600 includes a CPU 601, a ROM 602, a RAM 603, an electrically erasable and programmable ROM (EEPROM) 604, a complementary metal oxide semiconductor (CMOS) sensor 605, an imaging element I/F 606, an acceleration and orientation sensor 607, a medium I/F 609, and a Global Positioning System (GPS) receiver 611.

The CPU 601 controls entire operation of the smartphone 600. The ROM 602 stores programs such as an IPL to boot the CPU 601. The RAM 603 is used as a work area for the CPU 601. The EEPROM 604 reads or writes various data such as a control program for the smartphone under control of the CPU 601.

The CMOS sensor 605 is an example of a built-in imaging device configured to capture an object (mainly, a self-image of a user operating the smartphone 600) under control of the CPU 601 to obtain image data. In alternative to the CMOS sensor 605, an imaging element such as a charge-coupled device (CCD) sensor can be used. The imaging element I/F 606 is a circuit that controls driving of the CMOS sensor 605. Examples of the acceleration and orientation sensor 607 include an electromagnetic compass or gyrocompass for detecting geomagnetism and an acceleration sensor.

The medium I/F 609 controls reading or writing (storing) of data from or to a storage medium 608 such as a flash memory. The GPS receiver 611 receives a GPS signal from a GPS satellite.

Further, the smartphone 600 includes a long-range communication circuit 612, a CMOS sensor 613, an imaging element I/F 614, a microphone 615, a speaker 616, a sound input/output (I/O) I/F 617, a display 618, an external device connection I/F 619, and a short-range communication circuit 620, an antenna 620a of the short-range communication circuit 620, and a touch panel 621.

The long-range communication circuit 612 is a circuit that enables the smartphone 600 to communicate with other device through the communication network 9. The CMOS sensor 613 is an example of a built-in imaging device configured to capture an object under control of the CPU 601 to obtain image data. The imaging element L/F 614 is a circuit that controls driving of the CMOS sensor 613. The microphone 615 is a built-in circuit that converts sound into an electric signal. The speaker 616 is a built-in circuit that generates sound such as music or voice by converting an electric signal into physical vibration.

The sound I/O L/F 617 is a circuit for inputting or outputting an audio signal between the microphone 615 and the speaker 616 under control of the CPU 601. The display 618 is an example of a display device configured to display an image of the object, various icons, etc. Examples of the display 618 include, but not limited to, a liquid crystal display (LCD) and an organic electroluminescence (EL) display.

The external device connection I/F 619 is an interface that connects the smartphone 600 to various external devices. The short-range communication circuit 620 is a communication circuit that communicates in compliance with the Near Field Communication (NFC), the BLUETOOTH (registered trademark), and the like. The touch panel 621 is an example of the input device configured to enable a user to operate the smartphone 600 by touching a screen of the display 618.

The smartphone 600 further includes a bus line 610. Examples of the bus line 610 include, but not limited to, an address bus and a data bus, which electrically connects the components illustrated in FIG. 4 such as the CPU 601.

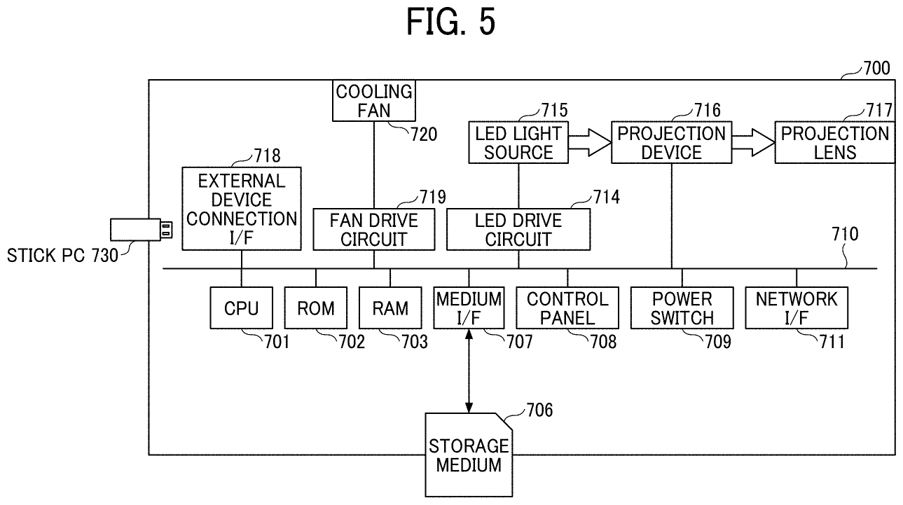

A projector 700, which is an example of the permanent terminal 4, may be implemented by a hardware configuration illustrated in FIG. 5, for example.

FIG. 5 is a block diagram illustrating an example of the hardware configuration of the projector 700, according to the present embodiment. As illustrated in FIG. 5, the projector 700 includes a CPU 701, a ROM 702, a RAM 703, a medium I/F 707, a control panel 708, a power switch 709, a bus line 710, a network I/F 711, a light emitting diode (LED) drive circuit 714, an LED light source 715, a projection device 716, a projection lens 717, an external device connection I/F 718, a fan drive circuit 719, and a cooling fan 720.

The CPU 701 controls entire operation of the projector 700. The ROM 702 stores a control program for controlling the CPU 701. The RAM 703 is used as a work area for the CPU 701. The medium I/F 707 controls reading or writing of data from or to a storage medium 706 such as a flash memory.

The control panel 708 is provided with various keys, buttons. LEDs, and the like, and is used for performing various operations other than controlling the power of the projector 700 by the user. For example, the control panel 708 receives an instruction operation such as an operation for adjusting the size of a projected image, an operation for adjusting a color tone, an operation for adjusting a focus, and an operation for adjusting a keystone, and outputs the received operation content to the CPU 701.

The power switch 709 is a switch for switching on or off the power of the projector 700. Examples of the bus line 710 include, but not limited to, an address bus and a data bus, which electrically connects the components illustrated in FIG. 5 such as the CPU 701. The network I/F 711 is an interface for performing data communication using the communication network 9 such as the internet.

The LED drive circuit 714 controls turning on and off of the LED light source 715 under the control of the CPU 701. The LED light source 715 emits projection light to the projection device 716 in response to turning on under the control of the LED drive circuit 714. The projection device 716 transmits modulated light obtained by modulating the projection light from the LED light source 715 by a spatial light modulation method based on image data provided through the external device connection I/F 718 and the like, through the projection lens 717, whereby an image is projected on a projection surface of the screen. A liquid crystal panel or a digital micromirror device (DMD) is used as the projection device 716, for example.

The LED drive circuit 714, the LED light source 715, the projection device 716, and the projection lens 717 function as a projection unit that projects an image on the projection surface based on image data.

The external device connection I/F 718 is directly connected to the PC and acquires a control signal and image data from the PC. Further, the external device connection I/F 718 is an interface for connecting various external devices such as a stick PC 730 and the like. The fan drive circuit 719 is connected to the CPU 701 and the cooling fan 720 and drives or stops the cooling fan 720 based on a control signal from the CPU 701. The cooling fan 720 rotates to exhaust air inside the projector 70), whereby cooling the inside of the projector 700.

When the power is supplied, the CPU 701 starts up according to the control program stored in advance in the ROM 702, supplies a control signal to the LED drive circuit 714 to turn on the LED light source 715, and supplies a control signal to the fan drive circuit 719 to rotate the cooling fan 720 at a rated speed. Further, when supply of power from the power supply circuit is started, the projection device 716 enters an image displayable state, and power is supplied from the power supply circuit to various other components of the projector 700. In response to turning off of the power switch 709 of the projector 700, a power-off signal is sent from the power switch 709 to the CPU 701.

In response to detection of the power-off signal, the CPU 701 supplies a control signal to the LED drive circuit 714 to turn off the LED light source 715. Then, when a predetermined time period elapses, the CPU 701 transmits a control signal to the fan drive circuit 719 to stop the cooling fan 720. Further, the CPU 701 terminates its own control processing, and finally transmits an instruction to the power supply circuit to stop supplying power.

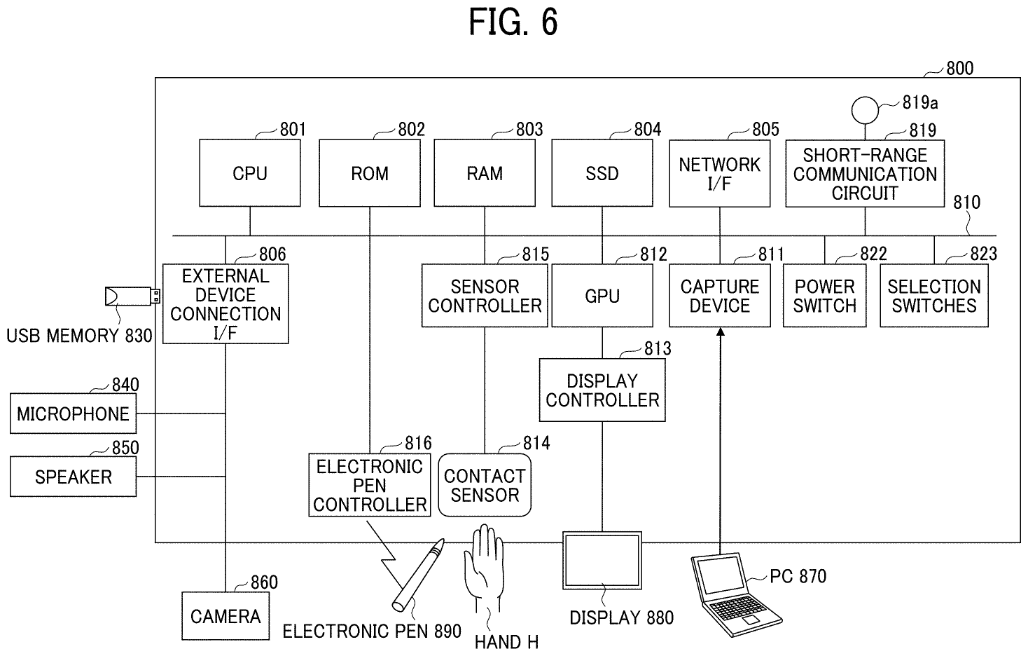

The IWB 800, which is an example of the permanent terminal 4, may be implemented by, for example, a hardware configuration illustrated in FIG. 6.

FIG. 6 is a block diagram illustrating an example of the hardware configuration of the IWB 800, according to the present embodiment. As illustrated in FIG. 6, the IWB 80) includes a CPU 801, a ROM 802, a RAM 803, a solid state drive (SSD) 804, a network V/F 805, and an external device connection I/F 806.

The CPU 801 controls entire operation of the IWB 800. The ROM 802 stores a control program for controlling the CPU 801, such as an IPL. The RAM 803 is used as a work area for the CPU 801. The SSD 804 stores various data such as the control program for the IWB. The network I/F 805 controls communication with the communication network 9. The external device connection I/F 806 is an interface that connects the IWB to various external devices. Examples of the external devices include, but not limited to, a USB memory 830, a microphone 840, a speaker 850, and a camera 860.

Further, the IWB 800 includes a capture device 811, a graphics processing unit (GPU) 812, a display controller 813, a contact sensor 814, a sensor controller 815, an electronic pen controller 816, a short-range communication circuit 819, an antenna 819a of the short-range communication circuit 819, a power switch 822, and selection switches 823.

The capture device 811 causes a display of an external PC 870 to display video data as a still image or a moving image. The GPU 812 is a semiconductor chip dedicated to graphics processing. The display controller 813 controls display of an image processed at the GPU 812 for output through a display 880 provided with the IWB 800.

The contact sensor 814 detects a touch on the display 880 by an electronic pen 890 or a user's hand H. The sensor controller 815 controls operation of the contact sensor 814. The contact sensor 814 senses a touch input to a particular coordinate on the display 820 using the infrared blocking system. More specifically, the display 880 is provided with two light receiving elements disposed on both upper side ends of the display 880, and a reflector frame surrounding the sides of the display 880. The light receiving elements emit a plurality of infrared rays in parallel to a surface of the display 880. The light receiving elements receive lights passing in the direction that is the same as an optical path of the emitted infrared rays, which are reflected by the reflector frame.

The contact sensor 814 outputs an identifier (ID) of the infrared ray that is blocked by an object (such as the user's hand) after being emitted from the light receiving elements, to the sensor controller 815. Based on the ID of the infrared ray, the sensor controller 815 detects a particular coordinate that is touched by the object. The electronic pen controller 816 communicates with the electronic pen 890 to detect a touch by the tip or bottom of the electronic pen 890 to the display 88t0. The short-range communication circuit 819 is a communication circuit that communicates in compliance with the NFC, the BLUETOOTH, and the like. The power switch 822 turns on or off the power of the IWB 800. The selection switches 823 are a group of switches for adjusting brightness, hue, etc., of display on the display 880, for example.

The IWB 80) further includes a bus line 810. Examples of the bus line 810 include, but not limited to, an address bus and a data bus, which electrically connects components illustrated in FIG. 6 such as the CPU 801.

The contact sensor 814 is not limited to the infrared blocking system type, and may be a different type of detector, such as a capacitance touch panel that identifies the contact position by detecting a change in capacitance, a resistance film touch panel that identifies the contact position by detecting a change in voltage of two opposed resistance films, or an electromagnetic induction touch panel that identifies the contact position by detecting electromagnetic induction caused by contact of an object to a display. In addition to or in alternative to detecting a touch by the tip or bottom of the electronic pen 890, the electronic pen controller 816 may also detect a touch by another part of the electronic pen 890, such as a part held by a hand of the user.

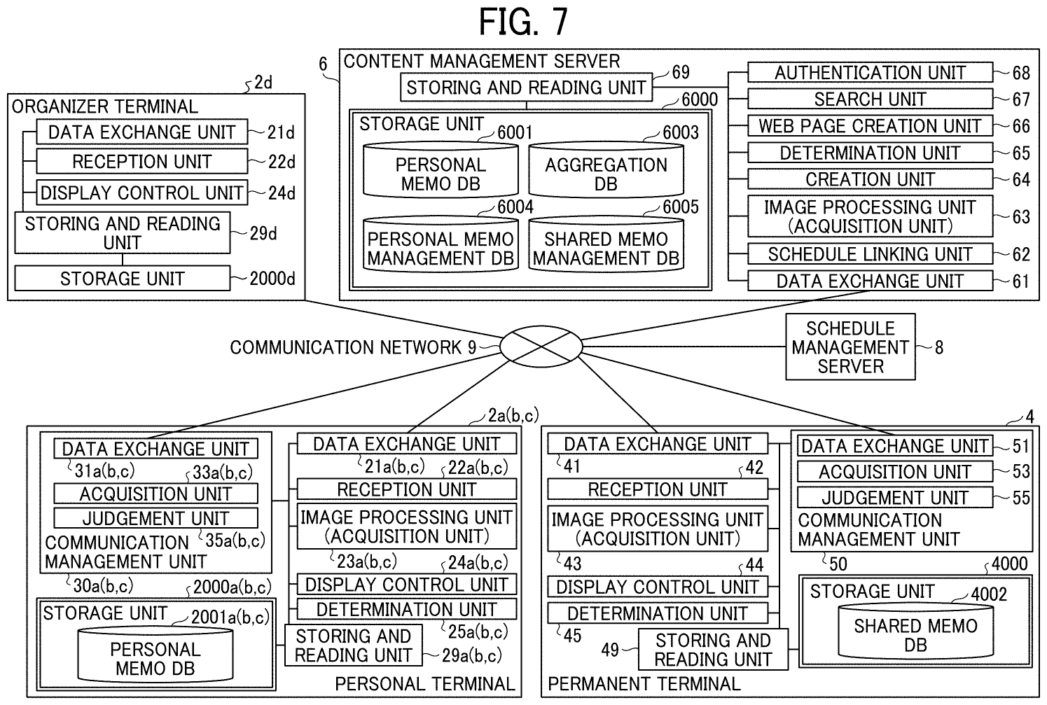

The functional configuration of each terminal and server included in the information processing system is described with reference to FIG. 7. FIG. 7 is a block diagram illustrating an example of the functional configuration of the information processing system.

The functional configuration of the personal terminal 2a is described. As illustrated in FIG. 7, the personal terminal 2a includes a data exchange unit 21a, a reception unit 22a, an image processing unit (acquisition unit) 23a, a display control unit 24a, a determination unit 25a, a storing and reading unit 29a, and a communication management unit 30a. These units are functions implemented by or caused to function by operating one or more hardware components illustrated in FIG. 3 in cooperation with instructions of the CPU 501 according to the program loaded from the HD 504 to the RAM 503. The personal terminal 2a further includes a storage unit 2000a, which is implemented by the RAM 503 and the HD 504 illustrated in FIG. 3.

The data exchange unit 21a, the reception unit 22a, the image processing unit (acquisition unit) 23a, the display control unit 24a, the determination unit 25a, and the storing and reading unit 29a are implemented by a web browser (web application) that displays a personal board screen described below. The communication management unit 30a is implemented by a dedicated communication application.

The functional configuration of the personal terminal 2a is described in detail. The data exchange unit 21a transmits and receives various data (or information) to and from other terminals, apparatuses, servers, etc. through the communication network 9. For example, the data exchange unit 21a receives from the content management server 6, content data described in a Hypertext Markup Language (HTML). Cascading Style Sheet (CSS), and JAVASCRIPT (registered trademark). In addition, the data exchange unit 21a transmits operation information input by the user to the content management server 6.

The reception unit 22a receives various selections or instructions input by the user using the keyboard 511 and the pointing device 512. For example, the input of text information by the user is received from the keyboard 511. The image processing unit 23a performs processing such as creating vector data (or stroke data) according to drawing operation of the pointing device 512 by the user. The image processing unit 23 includes a function as an acquisition unit. For example, the image processing unit 23 captures and acquires an image of the shared screen ss.

The display control unit 24a causes the display 506 to display a personal board screen described below. In addition, various aggregation results and the like are displayed on the display 506. The determination unit 25a performs various determinations. The storing and reading unit 29a is implemented by instructions from the CPU 501, and the HDD controller 505, the medium L/F 516, and the DVD-RW drive 514. The storing and reading unit 29a stores various data in the storage unit 2000a, the DVD-RW 513, and the storage medium 515, and reads the various data from the storage unit 2000a, the DVD-RW 513, and the storage medium 515.

The communication management unit 30a, which is implemented mainly by instructions of the CPU 501 illustrated in FIG. 3, performs data exchange with the data exchange unit 21a and the like. The communication management unit 30a further includes a data exchange unit 31a, an acquisition unit 33a, and a judgement unit 35a.

The data exchange unit 31a transmits and receives various data (or information) to and from the content management server 6 through the communication network 9 independent of the data exchange unit 21a. The function of the acquisition unit 33a is basically the same as the function as the acquisition unit of the image processing unit 23a. For example, the acquisition unit 33a performs screen capturing of the shared screen ss described below to acquire capture image. The judgement unit 35a makes various judgements, and judges, for example, whether the captured image is referenced by the user. Since the functional configurations of the personal terminals 2b and 2c are the same as the functional configurations of the personal terminals 2a, the description thereof is omitted.

The functional configuration of the organizer terminal 2d is described. As illustrated in FIG. 7, the organizer terminal 2d includes a data exchange unit 21d, a reception unit 22d, a display control unit 24d, and a storing and reading unit 29d. These units are functions implemented by or caused to function by operating one or more hardware components illustrated in FIG. 3 in cooperation with instructions of the CPU 501 according to the program loaded from the HD 504 to the RAM 503. The organizer terminal 2d further includes a storage unit 2000d, which is implemented by the RAM 503 and the HD 504 illustrated in FIG. 3.

The data exchange unit 21cd, the reception unit 22d, the display control unit 24d, and the storing and reading unit 29d are implemented by a web browser (a web application).

The functional configuration of the organizer terminal 2d is described in detail. The data exchange unit 21d transmits and receives various data (or information) to and from a server or the like through the communication network 9. For example, the data exchange unit 21d receives data described in HTML, CSS, and JAVASCRIPT (registered trademark) from the content management server 6.

The reception unit 22d receives various inputs from the organizer using the keyboard 511 and the pointing device 512.

The display control unit 24d displays the organizer portal screen, which is described below, on the display 506 and displays the aggregation result and the like. The storing and reading unit 29d is implemented by instructions from the CPU 501, and the HDD controller 505, the medium I/F 516, and the DVD-RW drive 514. The storing and reading unit 29d stores various data in the storage unit 2000d, the DVD-RW 513, and the storage medium 515, and reads the various data from the storage unit 2000d, the DVD-R W 513, and the storage medium 515.

A description is now given of an example of a functional configuration of the permanent terminal 4. As illustrated in FIG. 7, the permanent terminal 4 includes a data exchange unit 41, a reception unit 42, an image processing unit (acquisition unit) 43, a display control unit 44, a determination unit 45, a storing and reading unit 49, and a communication management unit 50. These units are functions implemented by or caused to function by operating one or more hardware components illustrated in FIG. 5 in cooperation with instructions of the CPU 701 according to the program loaded from the storage medium 706 to the RAM 703.

Note that each unit may be a function implemented by operating any of the components illustrated in FIG. 5 by a command from the CPU of the stick PC 730 according to a program loaded on a RAM of the stick PC 730. Further, the permanent terminal 4 includes a storage unit 4000 implemented by the RAM 703 illustrated in FIG. 5 and the like. A shared memo DB 4002 is implemented in the storage unit 4000 of the permanent terminal 4.

The functions of the data exchange unit 41, the reception unit 42, the image processing unit (acquisition unit) 43, the display control unit 44, the determination unit 45, the storing and reading unit 49, the communication management unit 50, and the storage unit 4000 of the permanent terminal 4 are the same or the substantially the same as those of the data exchange unit 21a, the reception unit 22a, the image processing unit (acquisition unit) 23a, the display control unit 24a, the determination unit 25a, the storing and reading unit 29a, the communication management unit 30a, and the storage unit 2000a of the personal terminal 2a respectively, and therefore redundant descriptions thereof are omitted below. Further, the communication management unit 50 in the permanent terminal 4 includes a data exchange unit 51, an acquisition unit 53, and a judgement unit 55, which have the same function as the data exchange unit 31a, the acquisition unit 33a, and the judgement unit 35a, respectively and therefore redundant descriptions thereof are omitted below.

The data exchange unit 41, the reception unit 42, the image processing unit 43, the display control unit 44, the determination unit 45, and the storing and reading unit 49 are implemented by a web browser (web application) for displaying the shared board screen. The communication management unit 50 is implemented by the dedicated communication application.

A description is now given of an example of a functional configuration of the content management server 6. As illustrated in FIG. 7, the content management server 6 includes a data exchange unit 61, a schedule linking unit 62, an image processing unit (acquisition unit) 63, a creation unit 64, a determination unit 65, a web page creation unit 66, a search unit 67, an authentication unit 68 and a storing and reading unit 69. These units are functions implemented by or caused to function by operating one or more hardware components illustrated in FIG. 3 in cooperation with instructions of the CPU 501 according to the program loaded from the HD 504 to the RAM 503. The content management server 6 further includes a storage unit 6000, which is implemented by the RAM 503 and the HD 504 illustrated in FIG. 3.

A detailed description is given of each functional unit of the content management server 6. The data exchange unit 61 transmits and receives various data (or information) to and from other terminals, apparatuses, servers, etc. through the communication network 9. The schedule linking unit 62 acquires schedule information including the reference information of the meeting in which the user participates from a schedule management server 8 connected to the communication network 9 so as to be able to send and receive various data (or information). The schedule management server 8 stores schedule information (meeting (list) information) for each user (each user ID).

The image processing unit 63 has a function as an acquisition unit and performs screen capturing of the shared screen ss described below, to acquire a capture image. The creation unit 64 includes a “storage function”, a “registration function”, and a “calculation function”. The creation unit 64 creates a unique content ID, personal memo ID, etc., registers the IDs in associated information described below, or aggregates memos for each individual from the associated information to calculate the degree of interest. The determination unit 65 determines whether the content ID and the personal memo ID have been received by the data exchange unit 61.

The web page creation unit 66 creates web page data to be displayed on the web browsers of the personal terminal 2, the organizer terminal 2d, and the permanent terminal 4. The search unit 67 receives a search request from the personal portal screen described below displayed on the web browsers of the personal terminal 2 and the permanent terminal 4 and performs a search according to the search request. Further, the search unit 67 receives a search request from the organizer portal screen described below displayed on the web browser of the organizer terminal 2d and performs a search according to the search request. The authentication unit 68 performs an authentication process for the user and the organizer. The authentication unit 68 can be provided in any suitable sources other than the content management server 6. For example, an authentication server connected to the communication network 9 can be used.

The storing and reading unit 69 includes a “storage function”. The storing and reading unit 69 is implemented by instructions from the CPU 501, and the HDD controller 505, the medium I/F 516, and the DVD-RW drive 514 and stores various data in the storage unit 600, the DVD-RW 513, and the storage medium 515, and reads the various data from the storage unit 6000, the DVD-RW 513, and the storage medium 515.

Further, in the storage unit 6000 of the content management server 6, as an example of “associated information”, a personal memo DB 6001, an aggregation DB 6003, a personal memo management DB 6004, and a shared memo management DB 6005 are implemented.

Note that these data may be stored in any suitable server other than the content management server 6. In that case, for example, the data may be acquired from another server each time data acquisition or transmission is requested from the personal terminal 2 or the organizer terminal 2d. In another example, the data may be stored in the content management server 6 while the meeting is being held or the personal board is being referenced by the user and deleted from the content management server 6 and transmitted to another server after the end of the meeting or the reference (or after a certain period of time).

The apparatuses or devices described in the embodiment are merely one example of plural computing environments that implement one or more embodiments disclosed herein. In some embodiments, the content management server 6 includes multiple computing devices, such as a server cluster. The plurality of computing devices is configured to communicate with one another through any type of communication link, including a network, shared memory, etc., and perform the processes disclosed herein. Similarly, the personal terminal 2 and the permanent terminal 4 may include multiple computing devices configured to communicate with one another.

Further, the content management server 6, the personal terminal 2, and the permanent terminal 4 can be configured to share the disclosed processing steps in various combinations. For example, a part of process to be executed by the content management server 6 can be executed by the personal terminal 2 or the permanent terminal 4. Further, each element of the content management server 6, the personal terminal 2, and the permanent terminal 4 may be integrated into one device or may be divided into a plurality of devices. Further, the content management server 6 and the organizer terminal 2d can be configured to share the processing steps described below in various combinations. For example, a part or all of process to be executed by the content management server 6 can be executed by the personal terminal 2.

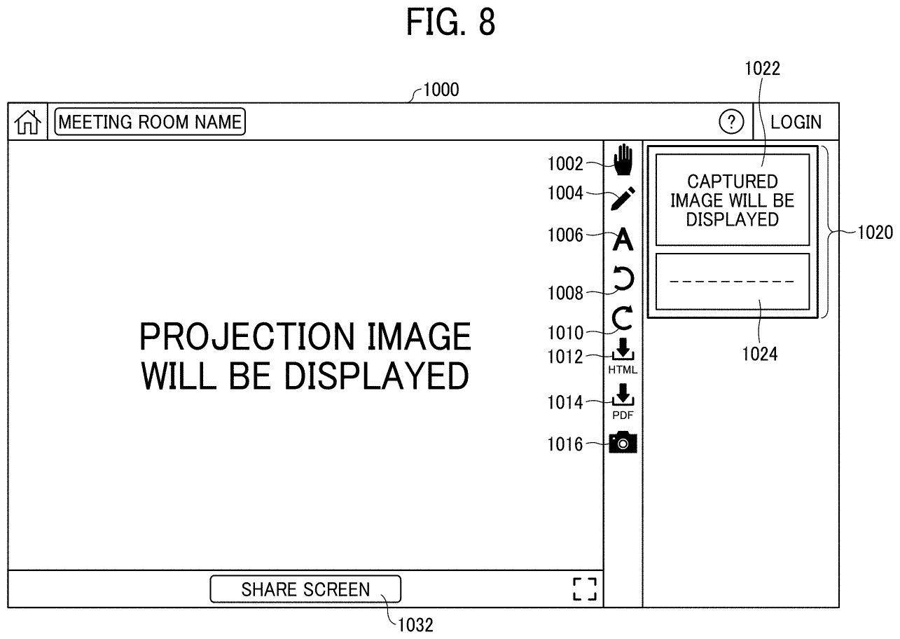

With reference to FIGS. 8 to 12, an example of displaying a personal board screen 1000 until the end of the meeting is described. The personal board screen 10X) is a screen for displaying information to be presented to the user with a graphical user interface (GUI) and receiving an operation from the user and is a display form of a web browser or application software.

As illustrated in FIGS. 8 to 12, the personal board screen 1000 until the end of the meeting includes a projection area for displaying the projection screen on the left side and a memo area on the right side. The shared screen ss is displayed as a projection screen in the projection area. In the memo area, a set of a captured image 1022 of the projection screen and a text memo area 1024 accompanying the captured image 1022 is displayed on a sheet 1020.

By pressing the capture button 1016, the user captures the projection screen displayed in the projection area, and the sheet 1020 displaying the combination of the captured image 1022 and the text memo area 1024 can be additionally displayed in the memo area. The pressing of the capture button 1016 is an example, and, for example, pressing a shortcut key from the keyboard or a gesture operation from the touch panel may be used for this operation.

FIG. 8 is an example of the personal board screen 1000 before the display of the projection screen and a first screen capture are performed. For example, on the personal board screen 1000 of FIG. 8, a guidance message “projection image will be displayed” is displayed in the projection area. Further, in the memo area of FIG. 8, a guidance message “captured image will be displayed” is displayed as the captured image 1022. By displaying such guidance messages on the personal board screen of FIG. 8, the user can imagine the screen image after the screen capture is performed before the first screen capture is performed. The guidance message may not be displayed. Further, the input from the user to the text memo area 1024 may be accepted even before the first screen capture is performed.

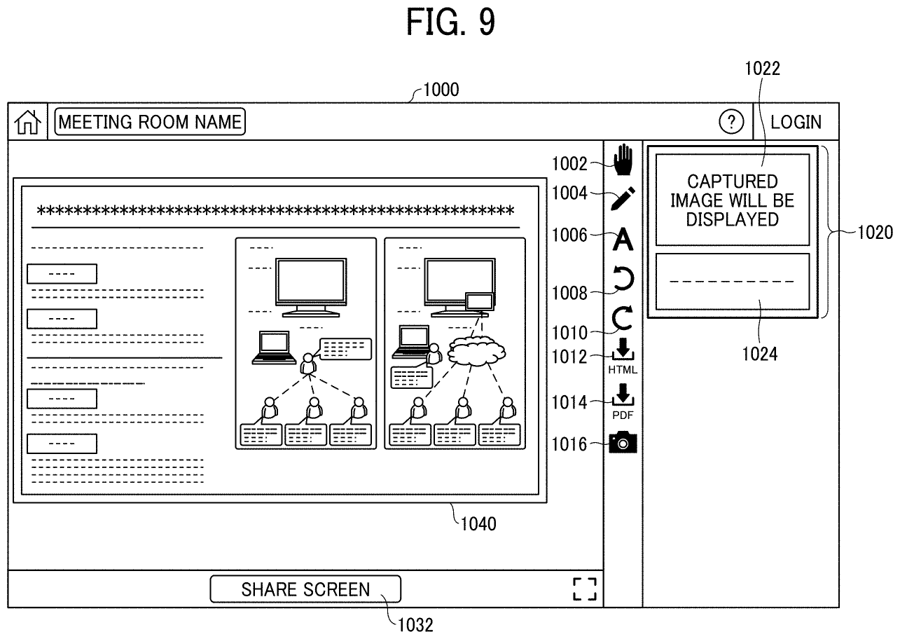

In response to a transmission of content data such as stream data (image sent by the organizer (meeting material data used for one meeting in this example)) to the shared screen ss, the personal board screen 1000 of FIG. 8 is replaced by the personal board screen 1000 as illustrated in FIG. 9. FIG. 9 is an example of the personal board screen 1000 on which a projection screen 1040 is displayed. In the projection area of FIG. 9, the stream data transmitted to the shared screen ss is displayed as the projection screen 1040.

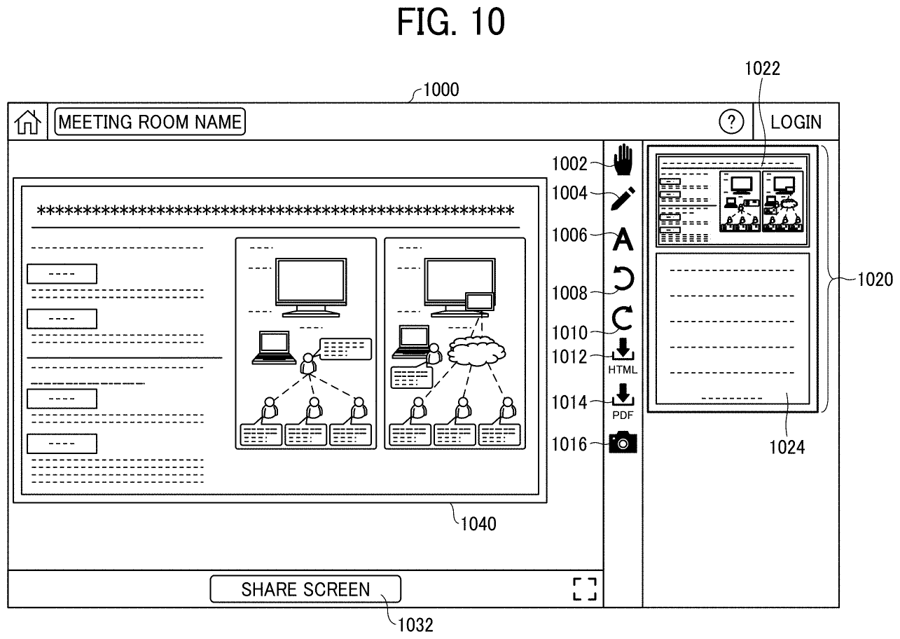

The personal board screen 1000 of FIG. 9 is replaced by the personal board screen 1000 of FIG. 10 in response to receiving the pressing of the capture button 1016 by the user. FIG. 10 is an example of the personal board screen 1000 in which the first screen capture is performed. For example, the personal board screen 1000 of FIG. 10 is an example of user interface (U) for displaying the shared screen ss and the personal board dc in one screen. In the personal board screen 1000 the display of the shared screen ss and the personal board dc may be switched by switching tabs.

By pressing the capture button 1016, the user can capture a current projection screen 1040 and display the captured image 1022 of the projection screen 1040 in the memo area. Further, the user can display the text memo area 1024 attached to the captured image 1022 in the memo area. By displaying the captured image 1022 and the text memo area 1024 attached to the captured image 1022 on, for example, one sheet 1020, the combination of the captured image 1022 and the text memo area 1024 is displayed in an easy-to-understand manner. In addition, in response to receiving the pressing of the capture button 1016 by the user, the current projection screen 1040 may be compared with the captured image 1022 of the projection screen 104) displayed in the memo area to prevent capturing the same image.

The mouse cursor is aligned with a first line of the newly displayed text memo area 1024 in response to receiving the pressing of the capture button 1016 by the user. Accordingly, the user can easily shift from the operation of pressing the capture button 1016 to the text memo operation in the text memo area 1024. The text memo area 1024 extends downward finitely or infinitely according to the input of the text memo by the user.

In addition, an object can be drawn on the captured image 1022 using a pen tool or the like. On the personal board screen 1000, a tool palette including a hand tool button 1002, a pen tool button 1004, a text tool button 1006, an undo button 1008, a redo button 1010, an HTML save button 1012, a Portable Document Format (PDF) save button 1014, and a capture button 1016 is displayed.

The hand tool button 1002 is a button to allow the user to start using a hand tool. By using the hand tool, the user can select an object drawn on the captured image 1022 and move the object by dragging and dropping. The pen tool button 1004 is a button to allow the user to start using a pen tool. By using the pen tool, the user can select a color and a line thickness and draw an object on the captured image 1022.

The text tool button 1006 is a button to allow a user to start using a text tool. By using the text tool, the user can generate a text area on the captured image 1022 and input text. The undo button 1008 is a button for undoing work previously done. The redo button 1010 is a button for redoing work undone with the undo button 1008.

The HTML save button 1012 is a button for saving the information on the personal board screen 1000 as an HTML file in local environment. The PDF save button 1014 is a button for saving the captured image 1022 and the text memo area 1024 displayed in the memo area of the personal board screen 1000 as a PDF file in the local environment. The capture button 1016 is a button for capturing the projection screen 1040 displayed in the projection area and newly displaying the sheet 1020 displaying the combination of the captured image 1022 and the text memo area 1024 in the memo area.

The object drawn on the captured image 1022 may be deleted by pressing a delete key or a backspace key. Further, the sheet 1020 may also be deleted by pressing the delete key or the backspace key.

During editing such as drawing the object on the captured image 1022 and inputting the text memo in the text memo area 1024, the projection area may be reduced and the memo area expanded to facilitate editing operations. The projection area may be reduced and the memo area may be enlarged automatically by the web application, or by the user's operation of moving the tool palette to the left.

Further, the sheet 1020 in which the captured image or the text memo area 1024 is being edited may be surrounded by a frame line or the color of the sheet 1020 may be changed so as to be visually distinguished.

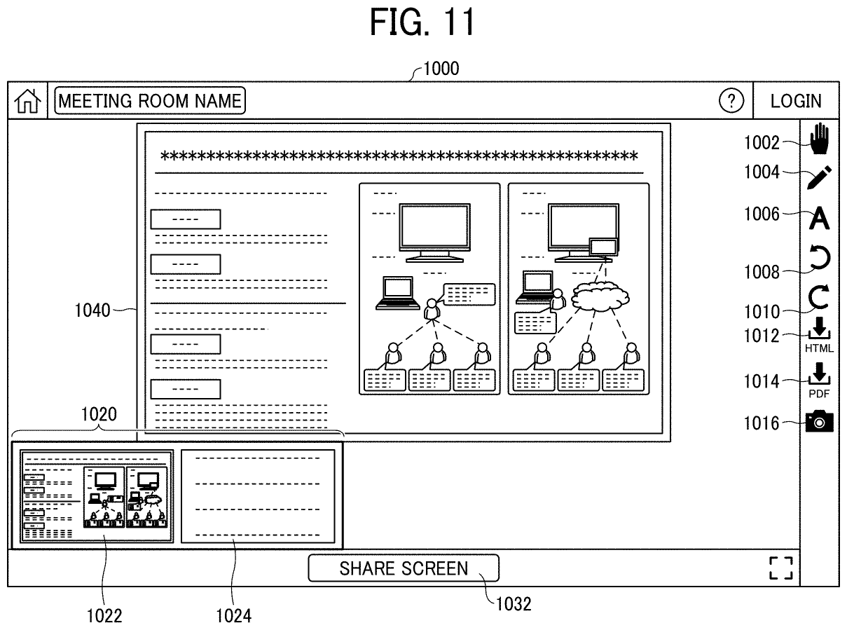

The memo area is not limited to be displayed on the right side of the personal board screen 1000 and may be displayed on the left side or on the lower side as illustrated in FIG. 11. FIG. 11 is a diagram illustrating an example of the personal board screen 1000 displaying the memo area on the lower side. By pressing the capture button 1016, the user captures the projection screen 1040 displayed in the projection area and displays the sheet 1020 displaying the combination of the captured image 1022 and the text memo area 1024 in the memo area.

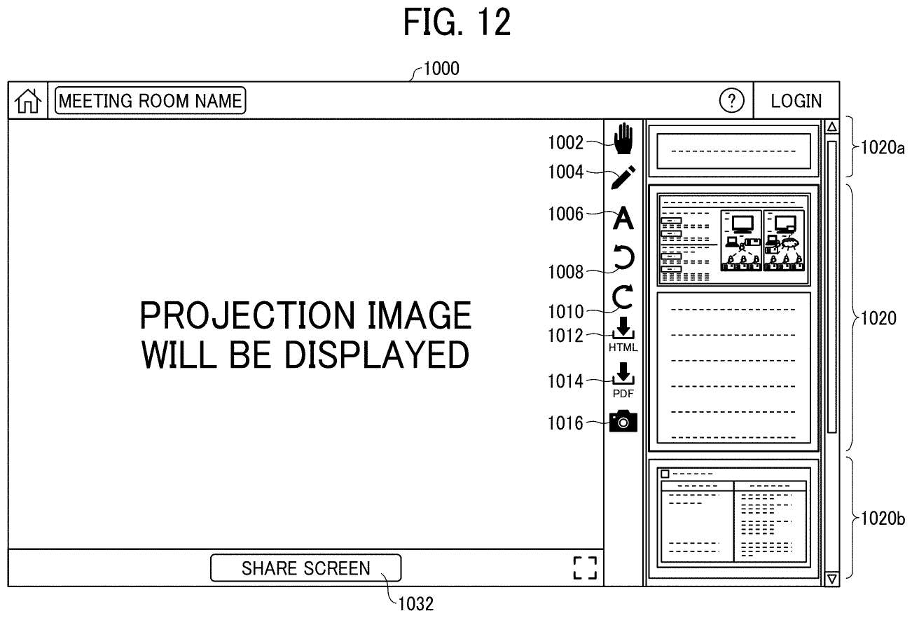

In response to receiving the pressing of the capture button 1016 by the user three or more times, the personal board screen 1000 displays a plurality of sheets 1020a, 1020, and 1020b in the memo area as illustrated in FIG. 12, for example. FIG. 12 is a diagram illustrating an example of the personal board screen 1000 displaying three or more screen captures.

As illustrated in FIG. 12, every time the user presses the capture button 1016, each of a plurality of sheets 1020a, 1020, and 1020b is added so as to be arranged in the vertical direction of the memo area in the personal board screen 1000.

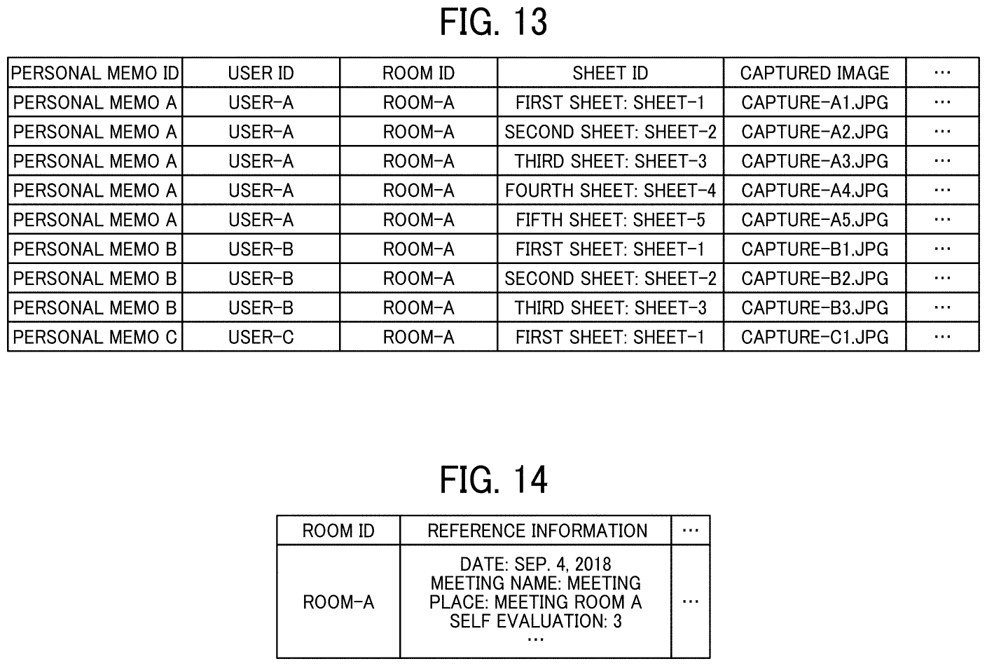

FIG. 13 is a table illustrating an example of a configuration of the personal memo management DB 6004 (refer to FIG. 7). The personal memo management DB 6004 as illustrated in FIG. 13 is stored in the storage unit 6000 of the content management server 6. The personal memo management DB 6004 of FIG. 13 stores a personal memo ID, a user ID, a room ID, a sheet ID, and a captured image in association with each other.

The item “personal memo ID” is an example of personal memo identification information that identifies a personal memo dm of the personal board dc. The item “user ID” is an example of user identification information that identifies the user. The item “room ID” is an example of room identification information that identifies a room. The item “sheet ID” is an example of sheet identification information that identifies the sheet 1020. The item “captured image” is an example of image file identification information for identifying an image file in which the projection screen 1040 is captured. The “room ID” can be used for identification information of the image transmitted by the organizer (in this example, the projected image of the meeting material data used for one meeting). The captured image captured by each user when the meeting material data is displayed is stored as the “captured image”.

Based on the user ID of the user who operates the personal terminal 2 stored in the personal memo management DB 6004 of FIG. 13, the room ID and the personal memo ID of the room in which the user participates can be identified. Further, based on the personal memo ID stored in the personal memo management DB 6004 of FIG. 13, for example, the sheet 1020 displayed on the personal board screen 1000 and the image file of the captured image 1022 displayed on the sheet 1020 can be identified.

FIG. 14 is a table illustrating an example of a configuration of the shared memo management DB 6005 (refer to FIG. 7). The shared memo management DB 6005 as illustrated in FIG. 14 is stored in the storage unit 6000 of the content management server 6. The shared memo management DB 6005 of FIG. 14 stores the room ID and the reference information of the meeting in association with each other.

The item “room ID” is an example of the room identification information that identifies the room. The item “reference information” is the reference information of the meeting held in the room identified by the room ID. Based on the room ID stored in the shared memo management DB 6005 of FIG. 14, the reference information of the meeting can be identified.

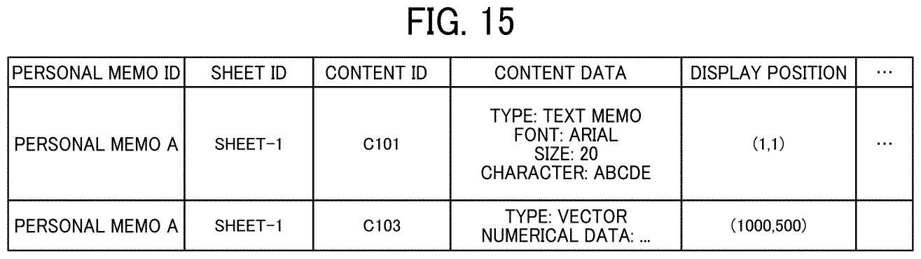

FIG. 15 is a table illustrating an example of a configuration of the personal memo DB 2001a. The personal memo DB 2001a as illustrated in FIG. 15 is stored in the storage unit 2000a of the personal terminal 2a. Since the personal memo DB 2001a is created in a cache of the web browser, the personal memo DB 2001a is present only while the web browser is activated.

The data stored in the personal memo DB 2001a is the same as the data for each personal terminal 2 stored in the personal memo DB 6001 in the content management server 6. The personal terminal 2a acquires the data for the personal terminal 2a from the data of each personal terminal 2 stored in the content management server 6 and stores the data in the personal memo DB 2001a.

The personal memo DB 2001a of FIG. 15 stores the personal memo ID, the sheet ID, a content ID, content data, and the like in association with each other.

The item “personal memo ID” is an example of personal memo identification information that identifies the personal memo dm of the personal board dc. The item “sheet ID” is an example of sheet identification information that identifies the sheet 1020. The item “content ID” is an example of content identification information that identifies each content such as the text memo or the drawn object input to the sheet 1020.

The item “content data” is information input to the sheet 1020, for example, data such as the text memo or the drawn object. For example, type of the content data having the content ID “C101” input to the text memo area 1024 or the like is a “text memo”, font type is “ARIAL”, font size is “20”, and characters “ABCDE” is input.

Further, the type of the content data of the content ID “C103” is vector data and is drawn on the captured image 1022 or the like. The vector data is represented by numerical data such as coordinate values in the captured image. For the text input to the captured image 1022 or the like by using the text tool, for example, by expressing the type of content data by “text” or the like, it is possible to distinguish between the text input in the captured image 1022 and the like and the text memo input in the text memo area 1024 and the like.

Since the personal memo DB 6001 has the same data structure as the personal memo DB 2001a, the description thereof is omitted. Note that the personal memo DB 6001 stores all data of the personal memo DBs 2001a, 2001b, and 2001c.

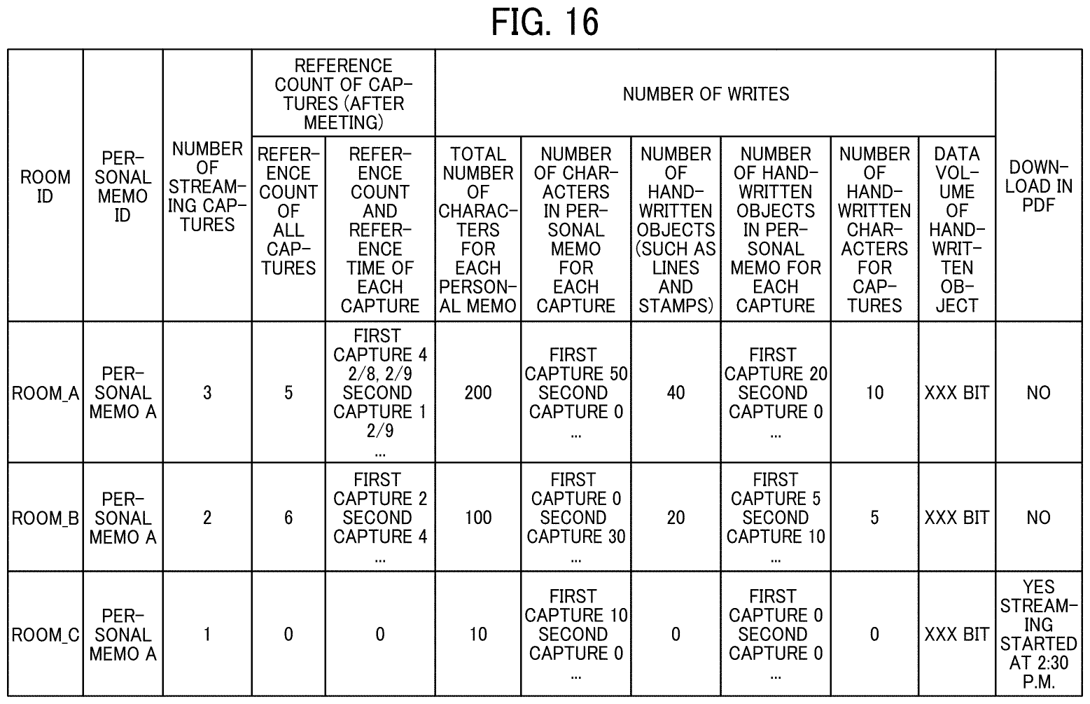

FIG. 16 is a table illustrating an example of a configuration of the aggregation DB 6003. An aggregation table as illustrated in FIG. 16 is generated for each individual in the aggregation DB 6003 of the storage unit 600 of the content management server 6. The aggregation table of FIG. 16 stores the room ID, the personal memo ID, a number of captures of streaming, a reference count of captures, a number of writes, and download in PDF in association with each other.

The item “room ID” is an ID given to each meeting.

The item “personal memo ID” is personal memo identification information that identifies the personal memo dm of the personal board dc. The item “number of captures of streaming” is the number of times the user has taken a capture of the projection screen 1040 on the personal board screen 1000 of the room identified by the personal memo ID.

The item “reference count of captures” is an example of the reference count in which the user refers to the sheet 1020 on the personal board screen 1000 of the room identified by the personal memo ID after the meeting. The reference count of captures includes a reference count of all captures, and a reference count and a reference time of each capture.

The reference count and reference time for each capture are the number of times and the date and time for each sheet 1020 in which the user referred to the sheet 1020 on the personal board screen 1000 of the room identified by the personal memo ID. The reference count of the total number of captures is the total number of times for each sheet 1020 that the user referred to.

The item “number of writes” is the number of writes made by the user on the sheet 1020 on the personal board screen 1000 of the room identified by the personal memo ID. In this example, as an example of the number of writes, total number of text characters for each personal memo, number of characters in personal memo for each capture, number of handwritten objects (such as lines and stamps), number of handwritten objects in personal memo for each capture, number of handwritten characters in capture, and data volume (bit) of the handwritten object are included. The data for each item is set by aggregating the content data of each individual's personal memo DB (refer to FIG. 15) for each room (that is, for each meeting). For example, the number of characters is counted from the characters stored in the content data of the personal memo DB (refer to FIG. 15). The data volume of the handwritten object is the amount of data obtained from a length of trajectory from a start point to an end point of the characters in the vector data.

The total number of characters for each personal memo is the total number of characters obtained by adding the number of characters for each text memo area 1024 such as the sheet 1020. The number of text characters for each capture in the personal memo is the number of text characters for each text memo area 1024 such as the sheet 1020.

The number of handwritten objects (lines, stamps, etc.) is the total number of objects obtained by adding the number of handwritten objects for each captured image 1022 such as the sheet 1020. The number of handwritten objects in each capture in the personal memo is the number of handwritten objects for each captured image 1022 such as the sheet 1020.

The number of handwritten characters for the capture is the total number of characters obtained by adding the number of handwritten characters for each captured image 1022 such as the sheet 1020. The data volume of the handwritten object is the total data volume obtained by adding the data volume of the handwritten object for each captured image 1022 such as the sheet 1020.

The item “download in PDF” indicates whether the captured image 1022 and the text memo area 1024 displayed in the memo area of the personal board screen 1000 are saved (downloaded) as a PDF file in the local environment by the above-mentioned PDF save button 1014.

A description is given below of an operation or process according to the present embodiment. In the present embodiment, in the meeting held in the room, a presenter who is an example of the user who operates the personal terminal 2a performs streaming transmission to the shared screen ss, and a participant who is an example of the user who operates the personal terminal 2b participates in the meeting.

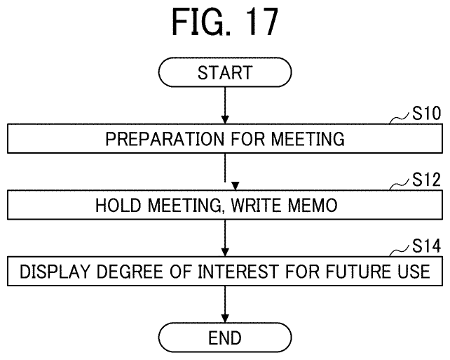

FIG. 17 is a flowchart illustrating an example of an entire process executed by the information processing system. In step S10, the information processing system prepares for the meeting. In the preparation for the meeting, the information processing system prepares the room based on the request from the personal terminal 2 or the permanent terminal 4 by the presenter and connects the personal terminal 2a and the personal terminal 2b to the room. The personal board screen 1000 as illustrated in FIG. 8 is displayed on the personal terminal 2a and the personal terminal 2b connected to the room.

In step S12, a meeting is held in the information processing system. In response to the request from the presenter's personal terminal 2, the information processing system performs streaming transmission to the shared screen ss of the room and causes each personal terminal 2 to display the projection screen 1040 as illustrated in the personal board screen 1000 of FIG. 9. Participants perform an operation of pressing the capture button 1016 displayed on the personal board screen 1000 at a desired timing while referring to the projection screen 1040 displayed on the personal board screen 1000.

In response to receiving the pressing of the capture button 1016 by the participant, the personal board screen 100) captures the captured image 1022 of the current projection screen 1040. Then, for example, as illustrated in the memo area of the personal board screen 1000 in FIG. 10, the captured image 1022 and the text memo area 1024 attached to the captured image 1022 are displayed on one sheet 1020.

As described above, the participant can display the captured image 1022 of the projection screen 1040 and the text memo area 1024 attached to the captured image 1022 additionally in the memo area at a desired timing. The participant inputs text memo in the text memo area 1024 displayed in the memo area as illustrated in FIG. 10 and writes a memo such as drawing an object (inputting a handwritten memo) on the captured image 1022 displayed in the memo area. The entered data such as memos are stored in the corresponding table of the personal memo DB, the shared memo management DB, and the personal memo management DB. That is, the content data of the text memo or the handwritten memo is stored for each captured image in association with the room ID, the sheet TD, and the personal memo ID.

In step S14, based on a request from the organizer terminal 2d made by the organizer after the end of the meeting, the information processing system displays a degree of interest of the participants which is confirmed and utilized by the organizer for future meetings.

In one example, the degree of interest of the participants in the content of the meeting may be displayed not only to the organizer but also to the participants by abstracting the content. In another example, the display of the degree of interest of the participants in the content of the meeting may be viewed only by the organizer by restricting access. The organizer can view the degree of interest of the participants in the content of the meeting and utilize the degree of interest for the approach to the participants (sales, etc.) and the feedback to the next meeting as described below.

Further, by visualizing and providing the degree of interest of the participants in the content of the meeting, it is possible to promote the utilization in the approach to the participants (sales, etc.) and the feedback to the next meeting.

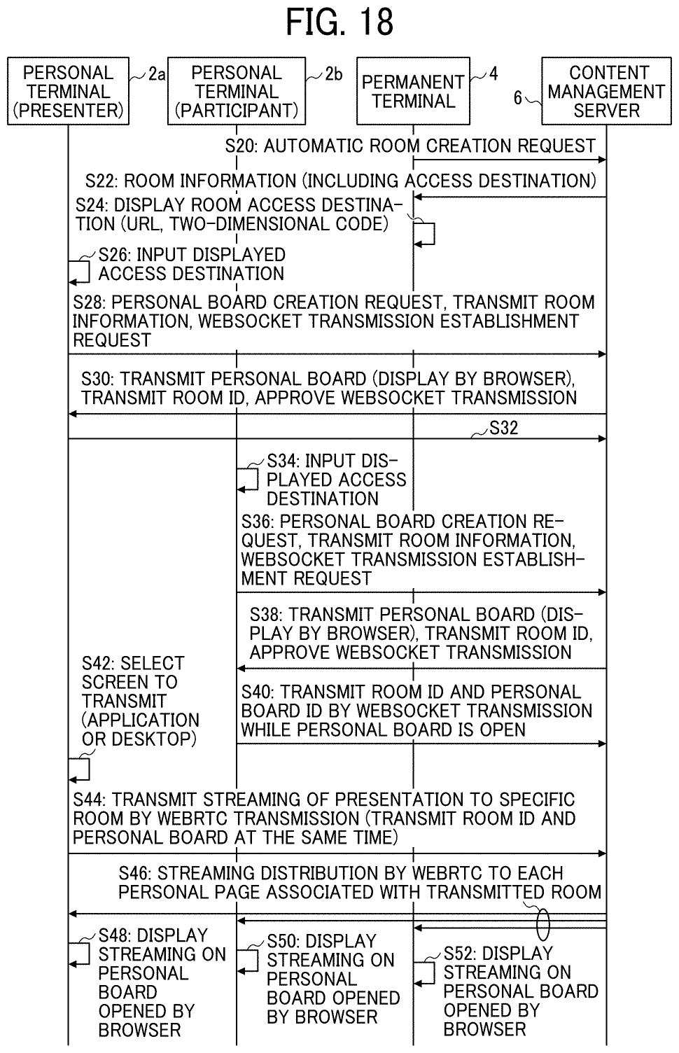

FIG. 18 is a sequence diagram illustrating an example of a process from meeting preparation to displaying the projection screen 1040 on the personal board screen 10). Steps S20 to S24 are steps executed at the end of the meeting (when leaving the room). In step S20, the permanent terminal 4 automatically makes a room creation request to the content management server 6 when leaving the previous meeting. In step S22, the content management server 6 creates a room and transmits the room information (including the access destination) of the created room to the permanent terminal 4. In step S24, the permanent terminal 4 displays the access destination of the room transmitted from the content management server 6 by a uniform resource locator (URL), a two-dimensional code, or the like. The permanent terminal 4 may not be included in the configuration in the case the participant knows the address for connecting to the room in advance, for example, the participants participating in the meeting are registered in advance in the content management server 6 and the address for connecting to the room is transmitted from the content management server 6 to each personal terminal 2. In the case the user who participates in the meeting wants to display the shared screen on a large screen in the configuration without the permanent terminal 4, the personal terminal 2 sharing the screen can output to the projector, the display, the electronic whiteboard, or the like.

In step S26, the presenter who operates the personal terminal 2a inputs into the web browser, the access destination of the room displayed by the permanent terminal 4. In step S28, the personal terminal 2a accesses the access destination input to the web browser, transmits the room information, and makes a personal board creation request and a WebSocket communication establishment request. WebSocket communication is a communication method different from HTTP for performing bidirectional communication (socket communication) between a web server and a web browser. By connecting the WebSocket communication, a Transmission Control Protocol (TCP) connection is established between the content management server 6 and the personal terminal 2 while displaying the page (here, the personal board) to be the target of the WebSocket communication, and both the content management server 6 and the web browser of the personal terminal 2 continue to communicate. In other words, when accessing the personal board, communication is made by HTTP including the handshake, switches to WebSocket communication and perform two-way communication after opening the personal board, and the WebSocket communication of the page ends in response to closing of the personal page.

In step S30, the content management server 6 transmits the personal board screen data and the room ID to the personal terminal 2a and approves the establishment of WebSocket communication. In step S32, the personal terminal 2a responds to the establishment approval of the WebSocket communication in step S30. In steps S28 to S30, the handshake by the HTTP protocol is performed between the personal terminal 2a and the content management server 6, and while the personal board screen 1000 is displayed, bidirectional communication can be performed by WebSocket communication.

In step S34, the participant who operates the personal terminal 2b inputs the access destination of the room displayed by the permanent terminal 4 to the web browser. In step S36, the personal terminal 2b accesses the access destination input to the web browser, transmits the room information, and makes the personal board creation request and the WebSocket communication establishment request.

In step S38, the content management server 6 transmits the personal board screen data and the room ID to the personal terminal 2b and approves the establishment of WebSocket communication. In step S40, the personal terminal 2b responds to the establishment approval of the WebSocket communication in step S38. In steps S36 to S38, the handshake by the HTTP protocol is performed between the personal terminal 2b and the content management server 6, and while the personal board screen 1000 is displayed, bidirectional communication can be performed by WebSocket communication.

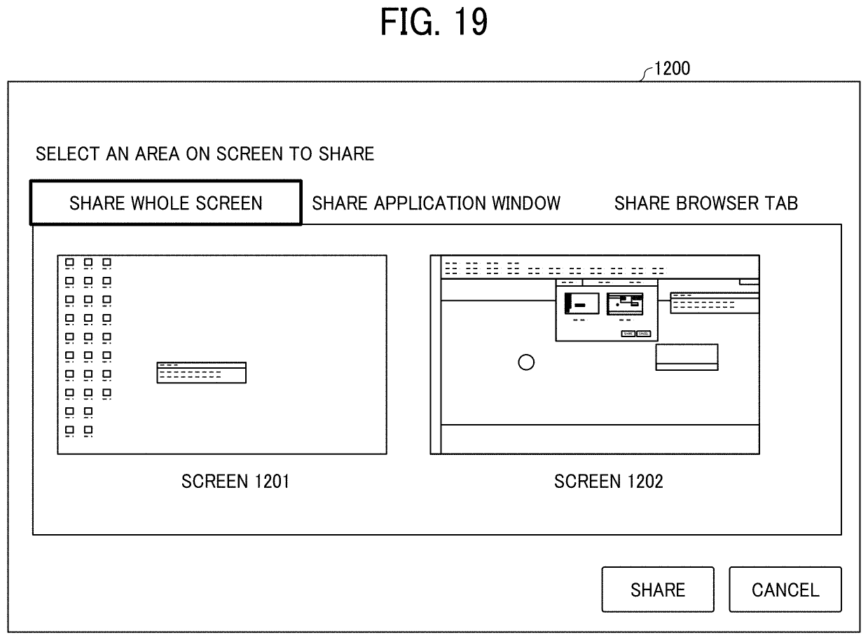

In step S42, the presenter who operates the personal terminal 2a selects a target screen to be transmitted from the screen 1200 as illustrated in FIG. 19, for example, to the shared screen ss. FIG. 19 is a diagram illustrating an example of a screen for selecting the target screen to be transmitted to the shared screen ss. FIG. 19 illustrates an example of the screen for selecting the target screen to be transmitted to the shared screen ss from “share whole screen”, “share application window”, and “share browser tab”.

Screen 1200 illustrated in FIG. 19 is an example in which the presenter selects “share whole screen”. A “screen 1201” in the screen 1200 indicates an option to transmit an entire desktop and a “screen 1202” in the screen 1200 indicates another option to transmit another screen of the two screens displayed on a dual display. In response to selecting “share application window” on the screen 1200, a plurality of activated applications (including an application for displaying a meeting or presentation material file) are displayed as options. In response to selecting “share browser tab” on the screen 1200, the tab of the activated web browser is displayed as an option.

In step S44, the personal terminal 2a designates the room ID or the personal board ID and transmits the streaming of the target screen to be transmitted to the shared screen ss of a specific room by Web Real-Time Communication (WebRTC). WebRTC is a standard that implements high-speed data communication through the web browser and is one of application programming interfaces (APIs) of HTML. WebRTC can send and receive large-capacity data such as video and audio in real time.

In step S46, the content management server 6 performs streaming distribution by WebRTC to the personal terminal 2a, the personal terminal 2b, and the personal board screen 1000 of the permanent terminal 4 associated with the room ID designated in step S44.

In step S48, the personal terminal 2a displays the stream distributed projection screen 1040 in the projection area of the personal board screen 100 displayed by the web browser, for example, as illustrated in FIG. 9. In step S50, the personal terminal 2a displays the stream distributed projection screen 1040 in the projection area of the personal board screen 10X) displayed by the web browser, for example, as illustrated in FIG. 9. Further, in step S52, the permanent terminal 4 displays the stream distributed projection screen 1040 in the projection area of the personal board screen 1000 displayed by the web browser, for example, as illustrated in FIG. 9.

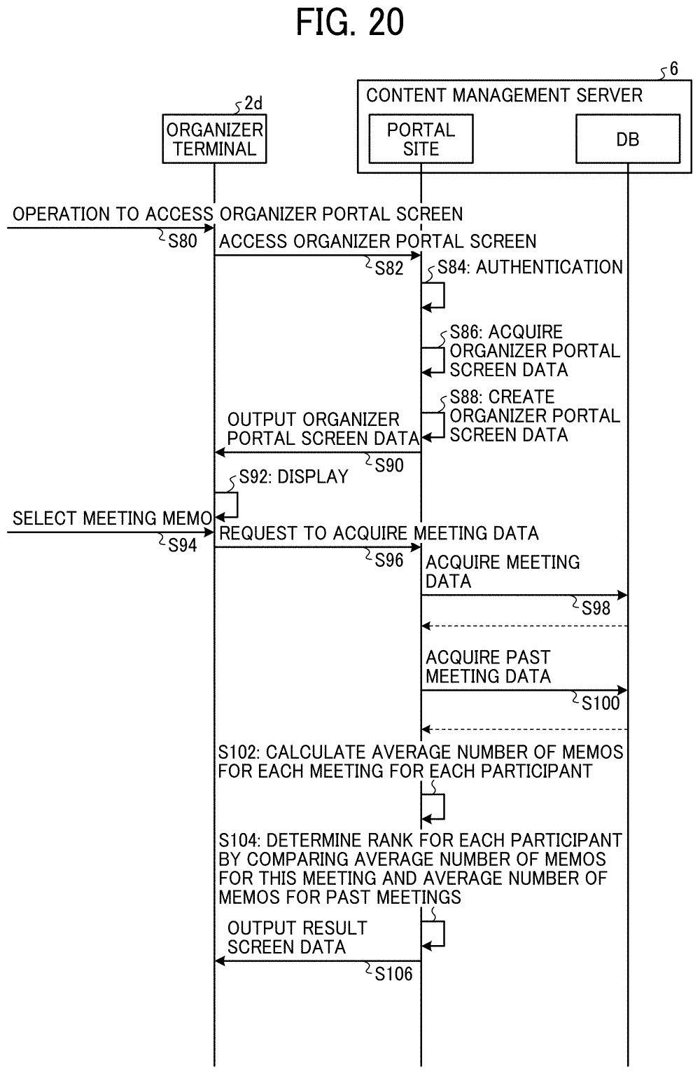

For example, a participant who operates the personal terminal 2b can capture the projection screen 1040 as the captured image 1022 and make a memo on the captured image 1022 and the text memo area 1024 by the process illustrated in the sequence diagram of FIG. 20.

FIG. 20 is a sequence diagram illustrating an example of a process of acquiring an aggregated result of an individual's interest in a meeting on the organizer terminal. FIG. 20 illustrates both the process executed by the organizer terminal 2d and the process executed by the content management server 6.

In step S80, the organizer performs an operation to access the portal screen for the organizer on the organizer terminal 2d. In step S82, the organizer terminal 2d accesses the portal site of the content management server 6 by the operation of the organizer.

In step S84, in response to receiving an access from the organizer terminal 2d, the portal site authenticates whether the access is from the organizer. In step S86, based on the authentication as the organizer, the portal site acquires the data for the organizer portal screen. In step S88, the portal site creates the data of the organizer portal screen. In step S90, the portal site outputs the data of the organizer portal screen to the organizer terminal 2d.

In step S92, the organizer terminal 2d displays the organizer portal screen received from the portal site and receives operation from the organizer.

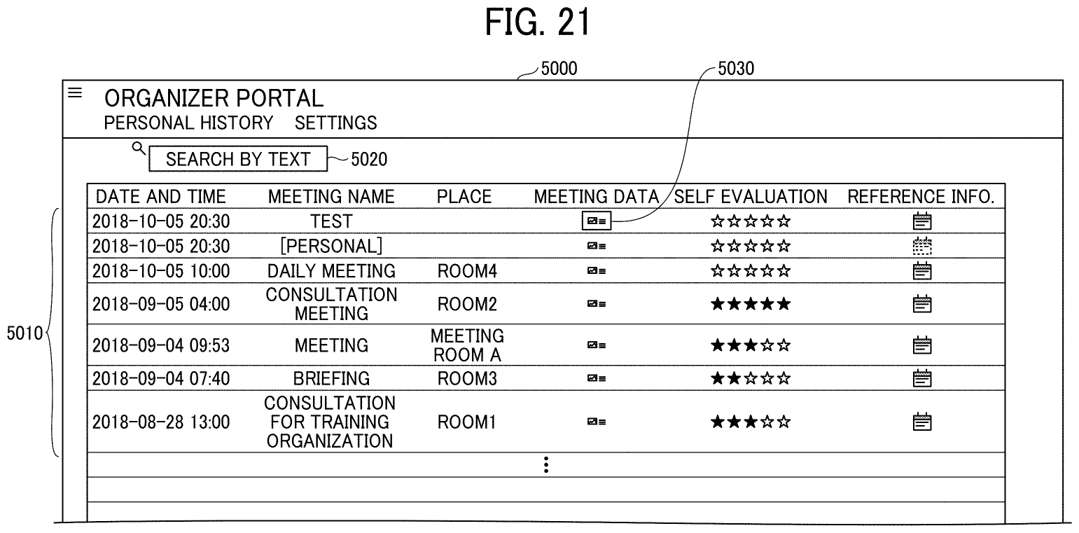

FIG. 21 is a diagram illustrating an example of a meeting list screen 5000 displayed on the organizer portal screen. The meeting list screen 5000 illustrated in FIG. 21 displays a list of search results by inputting a search word in a search box 5020. Seven meetings are included in a meeting list 5010 displayed on the meeting list screen 5000. From this list, the organizer selects a meeting to display the degree of interest of the participant. In this example, a meeting memo is selected from a meeting data selection field 5030.

In step S94, in response to receiving the selection of the meeting memo by operating the organizer portal screen by the organizer, the organizer terminal 2d requests the portal site of the content management server 6 to acquire the meeting data in step S96.

In step S98, in response to receiving the request for the meeting data from the organizer terminal 2d, the portal site of the content management server 6 acquires the data of the personal memo of the participant who participated in the meeting from the personal memo DB or the like.

In step S100, the portal site of the content management server 6 acquires the data of the personal memos of the meetings that the participant of the meeting have participated in the past from the personal memo DB or the like.

In step S102, the portal site of the content management server 6 calculates the average number of memos for each meeting for each participant. In step S104, the average number of memos in the current meeting is compared with the average number of memos in a plurality of past meetings for each participant, and the rank of the number of memos in the current meeting is determined.

In step S106, the portal site of the content management server 6 outputs the data of the determination result screen to the organizer terminal 2d.

On the organizer terminal 2d, the result screen output from the portal site is displayed, and the organizer utilizes the degree of interest of each participant in the current meeting.

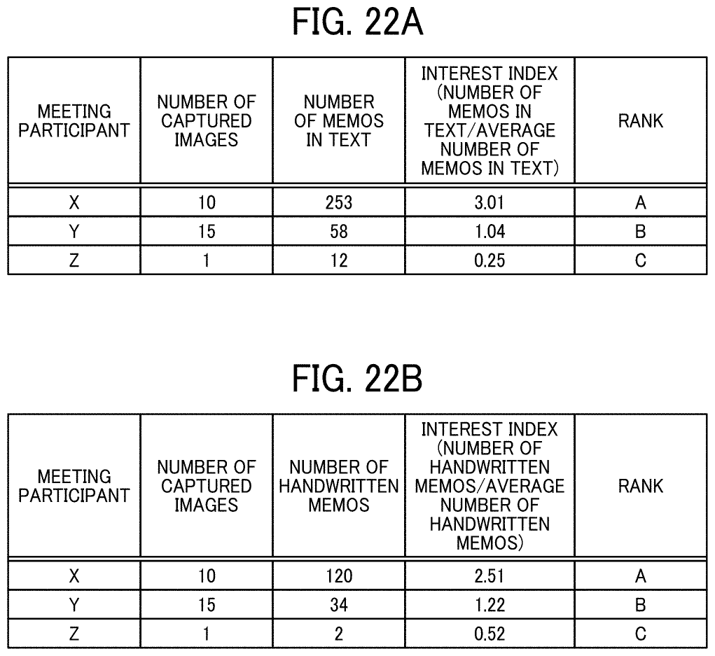

FIGS. 22A and 22B are tables illustrating examples of the result screen displayed on the organizer terminal 2d. FIG. 22A ranks the aggregated value obtained by totaling the number of characters input on the capture screen. FIG. 22B ranks data volume of the object handwritten on the capture screen. In this example, the result screen is displayed in a table format, but the result screen is not limited to this display format.

The result screen illustrated in FIG. 22A includes a meeting participant, a number of captured images, a number of memos in text, an interest index, and a rank. The item “meeting participant” indicates the participant who participated in the meeting of the organizer that requested the content management server to aggregate. The data of all the participants are acquired, but the data of some of the participants (participant X, participant Y, and participant Z) are indicated as an example.

The item “number of captured images” is the number of images captured by each participant at the meeting. The item “number of memos in text” is the total number of characters in the text memo entered by each participant at the meeting. The item “interest index (text memo/average number of text memos)” is a value obtained by dividing the total number of characters in the item “number of memos in text” by the average value obtained by averaging the total number of characters in each past meeting for each participant. In the case of participant X, the value of the item “interest index (text memo/average number of text memos)” is “3.01”, which indicates that participant X took memos nearly three times as much as the average number of memos participant X took at the past meetings. For participant Y, the value of the item “interest index (text memo/average number of text memos)” is “1.04”, which indicates that participant Y took more memos than the average number of memos in the past meetings. On the other hand, in the case of participant Z, the value of the item “interest index (text memo/average number of text memos)” is “0.25”, which is significantly smaller than the average number of memos in the past meetings.

In this example, in order to rank the interest index, the ranking is performed by a threshold value. As an example, the interest index of less than 1 is defined as rank “C”, the interest index of 1 or more and less than 2 is defined as rank “B”, and the interest index of 2 or more is defined as rank “A”. By performing the ranking and displaying the rank in this way, it is possible to judge at a glance the degree of interest of each participant in the meeting.

Further, the result screen illustrated in FIG. 22B includes the meeting participant, the number of captured images, a number of handwritten memos, the interest index, and the rank. The difference from FIG. 22A is that the ranking is performed not by the number of text memos but by the number of handwritten memos. The number of handwritten memos corresponds to the total volume of data of the objects handwritten on the captured image in the meeting. In this example, the number of handwritten memos of participant X is 120. The interest index is a value obtained by dividing the total volume of data indicated in the item “number of handwritten memos” of participant X by the average value obtained by averaging the total volume of data in each of the past meetings of participant X. In this example, the interest index is “2.51”, so there are more handwritten memos than in the past meetings. When ranked by the threshold value as before, A rank is obtained.

In this example, the ranks of the text memo and the handwritten memo are described, but either one of the ranks may be displayed or both may be displayed.

Further, the organizer terminal may perform a part or all of the aggregation process and the output process of the information indicating the interest index performed on the information processing apparatus as described in the present embodiment.

The method of providing the degree of interest of the meeting by the participants of the meeting to the organizer of the meeting according to the present embodiment is described as above. The meeting is described as an example, but the present disclosure can be applied not only to the meetings but also to product information sessions and the like. At the product information session, a large number of participants are expected in one room, but the present embodiment can be implemented as an index for the organizer to know the degree of interest of each participant. In addition, there are individual differences in participants, and some people take a lot of memos, while others take memos only on important things. In the present embodiment, tendency of a participant to take memo or not is obtained from a number of memos in meetings and the like that the participant has attended in the past. The degree of interest is calculated for each participant depending on whether the participant took more memos at the current meeting compared to the past meetings. Therefore, the degree of interest to the meeting can be obtained accurately.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. An information processing system comprising:
a plurality of information processing terminals; and
an information processing apparatus connected to the plurality of information processing terminals through a communication network, the information processing apparatus including circuitry configured to:
control to display an image transmitted from one of the plurality of information processing terminals on each of a plurality of displays of other information processing terminals of the plurality of information processing terminals;
store as associated information in one or more memories, input information input by each of respective users of the plurality of information processing terminals with respect to the image displayed on each information processing terminal in association with identification information of the image;
calculate, for each user, degree of interest in a specific image identified by specific identification information, by comparing an aggregated value of the input information related to the specific image identified by the specific identification information calculated from the associated information, with the aggregated value related to one or more other image each identified by another identification information different from the specific image identified by the specific identification information; and
cause the information processing terminal that transmitted the specific image identified by the specific identification information to display on the display, information indicating the degree of interest of each user related to the specific image identified by the specific identification information.

2. The information processing system of claim 1, wherein
the circuitry is further configured to store in one or more memories, as associated information for each user, information input to each image captured by each of the respective users of the plurality of information processing terminals in association with the identification information of the image displayed on each information processing terminal.

3. The information processing system of claim 1, wherein
the circuitry is configured to compare the aggregated value of the input information related to the specific image identified by the specific identification information for each user with an average of the aggregated values for the users related to the one or more other images, in alternative to comparing with the aggregated value.

4. The information processing system of claim 1, wherein
the input information is text information input by each of the respective users of the plurality of information processing terminals; and
the aggregated value is an aggregated number of characters of the text information.

5. The information processing system of claim 1, wherein
the input information is an object of a handwritten image input by the respective users of the plurality of information processing terminals with respect to a captured image of the image; and
the aggregated value is a volume of data of the object of the handwritten image.

6. The information processing system of claim 1, wherein
the circuitry is further configured to display on the display, rank information indicating the degree of interest of each user according to a ratio of aggregated values of the input information of the user related to the specific image identified by the specific identification information and the input information of the user related to the one or more other images each identified by the another identification information.

7. An information processing method executed by an information processing apparatus connected to a plurality of information processing terminals through a communication network, the information processing method comprising:
controlling to display an image transmitted from one of a plurality of information processing terminals on each of a plurality of displays of other information processing terminals of the plurality of information processing terminals;
storing as associated information in one or more memories, input information input by each of respective users of the plurality of information processing terminals with respect to the image displayed on each information processing terminal in association with identification information of the image;
calculating, for each user, degree of interest in a specific image identified by specific identification information, by comparing an aggregated value of the input information related to the specific image identified by the specific identification information calculated from the associated information, with the aggregated value related to one or more other images each identified by another identification information different from the specific image identified by the specific identification information; and
causing the information processing terminal that transmitted the specific image identified by the specific identification information to display on the display, information indicating the degree of interest of each user related to the specific image identified by the specific identification information.

8. A non-transitory recording medium storing a plurality of instructions which, when executed by one or more processors, causes the processors to perform an information processing method comprising:
controlling to display an image transmitted from one of a plurality of information processing terminals on each of a plurality of displays of other information processing terminals of the plurality of information processing terminals;
storing as associated information in one or more memories, input information input by each of respective users of the plurality of information processing terminals with respect to the image displayed on each information processing terminal in association with identification information of the image;
calculating, for each user, degree of interest in a specific image identified by specific identification information, by comparing an aggregated value of the input information related to the specific image identified by the specific identification information for each user calculated from the associated information, with the aggregated value related to one or more other images each identified by another identification information different from the specific image identified by the specific identification information; and
causing the information processing terminal that transmitted the specific image identified by the specific identification information to display on the display, information indicating the degree of interest of each user related to the specific image identified by the specific identification information.
